(19) United States
(12) Patent Application Publication
(10) Pub. No.: US 2026/0261874 A1
(43) Pub. Date: Sep. 3, 2026

(54) NETWORK CONFIGURATION FOR DIFFERENT DEVICE TYPES

(71) Applicant: Lenovo (United States) Inc., Morrisville, NC (US)

(72) Inventors: Karthikeyan Ganesan, Nauheim (DE); Ravi Kuchibhotla, Chicago, IL (US)

(73) Assignee: Lenovo (United States) Inc., Morrisville, NC (US)

(21) Appl. No.: 19/067,644

(22) Filed: Feb. 28, 2025

(51) Int. Cl. H04W 24/02; H04W 52/02

(52) U.S. Cl. CPC H04W 24/02; H04W 52/0235

(57) ABSTRACT

Various aspects of the present disclosure relate to network configuration for different device types. A network equipment (NE) (e.g., a BS) receives, from a user equipment (UE), an uplink (UL) wake-up signal (WUS) for on-demand transmission of one or more common channels or signals to provide cell coverage for a type of the UE. The NE activates a network configuration of a set of network configurations based at least in part on the UL WUS and the type of the UE. Each network configuration of the set of network configurations corresponds to a respective mode of operation of the NE associated with a respective type of UE of a set of types of UEs, and each respective type of UE corresponds to a respective cell coverage by the one or more common channels or signals.

### TECHNICAL FIELD

The present disclosure relates to wireless communications, and more specifically to network (e.g., base station (BS)) multiple configurations for different user equipment (UE) types.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

An NE (e.g., a BS) for wireless communication is described. The NE may be configured to, capable of, or operable to perform one or more operations as described herein. For example, the NE may be configured to, capable of, or operable to receive, from a UE, an UL WUS for on-demand transmission of one or more common channels or signals to provide cell coverage for a type of the UE; and activate a network configuration of a set of network configurations based on the UL WUS and the type of the UE, where each network configuration of the set of network configurations corresponds to a respective mode of operation of the NE associated with a respective type of UE of a set of types of UEs, and where each respective type of UE corresponds to a respective cell coverage by the one or more common channels or signals.

A processor (e.g., a standalone processor chipset, or a component of an NE) for wireless communication is described. The processor may be configured to, capable of, or operable to perform one or more operations as described herein. For example, the processor may be configured to, capable of, or operable to receive, from a UE, an UL WUS for on-demand transmission of one or more common channels or signals to provide cell coverage for a type of the UE; and activate a network configuration of a set of network configurations based on the UL WUS and the type of the UE, where each network configuration of the set of network configurations corresponds to a respective mode of operation of an NE associated with a respective type of UE of a set of types of UEs, and where each respective type of UE corresponds to a respective cell coverage by the one or more common channels or signals.

A method performed or performable by an NE (e.g., a BS) for wireless communication is described. The method may include receiving, from a UE, an UL WUS for on-demand transmission of one or more common channels or signals to provide cell coverage for a type of the UE; and activating a network configuration of a set of network configurations based on the UL WUS and the type of the UE, where each network configuration of the set of network configurations corresponds to a respective mode of operation of the NE associated with a respective type of UE of a set of types of UEs, and where each respective type of UE corresponds to a respective cell coverage by the one or more common channels or signals.

In some implementations of the NE, the processor, and the method described herein, the UL WUS is configured to identify the type of the UE. In some implementations of the NE, the processor, and the method described herein, the set of types of UEs include one or more of a first UE enabled for enhanced mobile broadband (eMBB); a second UE configured as an Internet-of-things (IoT) device; or a third UE configured as an IoT low power wide area network (LPWA) device.

In some implementations of the NE, the processor, and the method described herein, the NE, the processor, and the method may be configured to, capable of, or operable to implement a cell coverage enhancement level based on the UL WUS and the type of the UE. In some implementations of the NE, the processor, and the method described herein, the NE, the processor, and the method may be configured to, capable of, or operable to determine at least one of an on-demand mode of operation of the NE or the cell coverage enhancement level. In some implementations of the NE, the processor, and the method described herein, the cell coverage enhancement level includes an adapted common bandwidth (CBW) of the cell coverage.

In some implementations of the NE, the processor, and the method described herein, the set of network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA. In some implementations of the NE, the processor, and the method described herein, the NE, the processor, and the method may be configured to, capable of, or operable to conserve energy in an idle state; wake up responsive to the UL WUS; and activate the network configuration as at least one of the first network configuration, the second network configuration, or the at least third network configuration.

In some implementations of the NE, the processor, and the method described herein, the NE, the processor, and the method may be configured to, capable of, or operable to enable the first network configuration to provide eMBB cell coverage; receive a subsequent UL WUS for on-demand IoT LPWA cell coverage; and enable at least one of the second network configuration to provide the IoT LPWA cell coverage, or the at least third network configuration to provide both the eMBB cell coverage and the IoT LPWA cell coverage. In some implementations of the NE, the processor, and the method described herein, the NE, the processor, and the method may be configured to, capable of, or operable to enable the second network configuration to provide IoT LPWA cell coverage; receive a subsequent UL WUS for on-demand eMBB cell coverage; and enable at least one of the first network configuration to provide the eMBB cell coverage, or the at least third network configuration to provide both the eMBB cell coverage and the IoT LPWA cell coverage.

In some implementations of the NE, the processor, and the method described herein, the NE, the processor, and the method may be configured to, capable of, or operable to enable the second network configuration to provide IoT LPWA cell coverage; receive a subsequent UL WUS for an on-demand cell coverage enhancement level; and enable a different network configuration to provide at least the cell coverage enhancement level. In some implementations of the NE, the processor, and the method described herein, the NE, the processor, and the method may be configured to, capable of, or operable to enable the third network configuration to provide both eMBB cell coverage and IoT LPWA cell coverage; receive a subsequent UL WUS for an on-demand cell coverage enhancement level; and enable a different network configuration to provide at least the cell coverage enhancement level.

A UE for wireless communication is described. The UE may be configured to, capable of, or operable to perform one or more operations as described herein. For example, the UE may be configured to, capable of, or operable to transmit, to a NE, an UL WUS for on-demand transmission of one or more common channels or signals to provide cell coverage for a type of the UE; and receive, from the NE, an acknowledgement of a network configuration of a set of network configurations to provide the cell coverage based on the UL WUS and the type of the UE.

A processor (e.g., a standalone processor chipset, or a component of a UE) for wireless communication is described. The processor may be configured to, capable of, or operable to perform one or more operations as described herein. For example, the processor may be configured to, capable of, or operable to transmit, to a NE, an UL WUS for on-demand transmission of one or more common channels or signals to provide cell coverage for a type of a UE; and receive, from the NE, an acknowledgement of a network configuration of a set of network configurations to provide the cell coverage based on the UL WUS and the type of the UE.

A method performed or performable by a UE for wireless communication is described. The method may include transmitting, to a NE, an UL WUS for on-demand transmission of one or more common channels or signals to provide cell coverage for a type of the UE; and receiving, from the NE, an acknowledgement of a network configuration of a set of network configurations to provide the cell coverage based on the UL WUS and the type of the UE.

In some implementations of the UE, the processor, and the method described herein, the UL WUS is configured to identify the type of the UE as at least one of enabled for eMBB, an IoT device, or an IoT LPWA device. In some implementations of the UE, the processor, and the method described herein, the multiple network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA.

### BRIEF DESCRIPTION OF THE DRAWINGS

FIG. 1 illustrates an example of a wireless communications system in accordance with aspects of the present disclosure.

FIG. 2 illustrates an example of BS configurations for different modes of operation, in accordance with aspects of the present disclosure.

FIG. 3 illustrates an example of BS coverage enhancement levels and repetitions, in accordance with aspects of the present disclosure.

FIG. 4 illustrates an example of BS activity based on UE device types, in accordance with aspects of the present disclosure.

FIG. 5 illustrates an example of synchronization signal and physical broadcast channel (PBCH) configuration, in accordance with aspects of the present disclosure.

FIG. 6 illustrates an example of modification periods for repetition of the PBCH signal for IoT device types, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates a flowchart of a method performed by a UE in accordance with aspects of the present disclosure.

FIG. 11 illustrates a flowchart of a method performed by an NE (e.g., BS) in accordance with aspects of the present disclosure.

### DETAILED DESCRIPTION

In a wireless communications system, a UE and an NE (e.g., a BS, gNB, network entity, or network node) may support wireless communication, including reception and/or transmission of wireless communication, using time-frequency resources. For example, the UE and the NE may support communicating signals (e.g., carrying control information, data, and/or the like). It should be understood that various terms may be used interchangeably with “communicating,” such as “signaling,” “transmitting,” “receiving,” “outputting,” “forwarding,” “relaying,” “retrieving,” “obtaining,” and so forth.

In some cases, NEs may expend substantial energy when transmitting synchronization signal blocks (SSBs), a PBCH that includes a master information block (MIB), a system information block 1 (SIB1), as well as other system information (SI) and paging messages. In some networks, such as a legacy 5G network, the SIBs (other than SIB1, can be provided on-demand. The communication of SSB and SIB1 may be useful for cell identification, as well as for idle and connected mode mobility. However, continuous paging transmissions can result in unnecessary energy consumption, particularly if a few or none of the UEs being paged are present in a serving cell, where energy conservation is a priority.

Aspects of the present disclosure relate to enabling network energy saving by supporting efficient transmitting of common channels and SI for different types of UE (also referred to as UE device types). In some cases, a 6G network (e.g., a wireless communications system) may be deployed to support both eMBB and IoT UEs, including IoT LPWA UEs. The 6G air interface design can be unified for a single serving cell and single radio access technology (RAT), which can support multiple types of UEs, such as eMBB, IoT, and/or IoT LPWA.

The common channels and signals may be used in a wireless communications system or network to manage communications between UEs and the network (e.g., BS, gNBs). These common channels and signals provide for network operation and resource allocation and may include any one or more of a primary synchronization signal (PSS) used for initial synchronization to identify the beginning of a cell's frame; a secondary synchronization signal (SSS) used to identify the cell identity within the network; a PBCH for the initial network access; the PDCCH that provides control information to the UEs; a physical downlink shared channel (PDSCH) for SI; a physical random access channel (PRACH) for random access procedures, allowing user devices to request initial access to the network; a channel state information reference signal (CSI-RS) for measuring channel quality and optimizing data transmission; a demodulation reference signal (DM-RS); and a phase tracking reference signal (PT-RS) for tracking and correcting phase noise in high-frequency bands.

Network energy savings may be realized with 6G design by transitioning from an always-on network to an on-demand transmission for common channels and/or signals. Given that most of the network power consumption occurs at the NE (e.g., a BS, a RAN node), optimizing transmission and reception times can significantly reduce power usage. For example, transmission of IoT data can be scheduled during non-peak hours, such as when the serving cell load (e.g., traffic load) from eMBB UEs is minimal (e.g., less than or equal to a cell load threshold). With the network energy savings, IoT data can be transmitted during active time periods of the serving cell, thereby avoiding unnecessary temporal scheduling of IoT data. Instead, the NE may prioritize frequency division multiplexing (FDM) or code division multiplexing (CDM) of the IoT data to minimize extended active time periods.

Aspects of the present disclosure are described in the context of a wireless communications system.

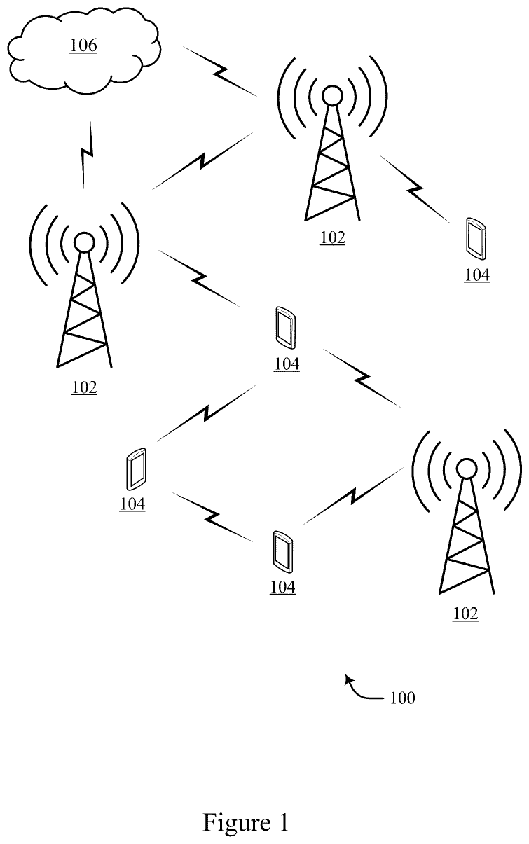

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a BS, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may enable network energy saving by implementing efficient transmission of the common channels and/or SI signaling for different UE device types. In some cases, a 6G network (e.g., a wireless communications system) may be implemented for both eMBB and IoT devices, such as IoT LPWA devices. The 6G air interface design can be unified for a single serving cell and single RAT, which can support multiple UE device types, such as eMBB, IoT, and/or IoT LPWA. Network energy savings may be realized with on-demand transmission of common channels and/or signals. Given that most of the network power consumption occurs in RAN, the transmit and reception times may be optimized to conserve as much power as possible. For example, IoT sensor data can be scheduled during non-peak hours, such as when the serving cell load for UE eMBB devices is minimal. With the network energy savings, IoT sensor data can be transmitted during active time periods of the serving cell, and the network avoids temporal scheduling of IoT data, prioritizing FDM or CDM of the IoT data to avoid long active time periods.

According to implementations, one or more of the NEs 102 and the UEs 104 are operable to implement various aspects of the techniques described with reference to the present disclosure. For example, an NE 102 (e.g., a BS, gNB) configures network configurations as modes of NE operation for different UE 104 device types, where one or more of the different UE device types are configured for different cell coverage by common channels and signals. The NE 102 receives, from a UE 104, an UL WUS as an on-demand request for a transmission of the common channels and signals to provide cell coverage for a device type of the UE. The NE 102 can activate a network configuration based on the UL WUS and the device type of the UE. The UE 104 transmits, to an NE 102, an UL WUS as an on-demand request for a transmission of common channels and signals to provide cell coverage for a device type of the UE. The UE 104 receives, from the NE 102, an acknowledgement of at least one of multiple network configurations enabled by the NE to provide the cell coverage based on the UL WUS and the device type of the UE.

With reference to network energy savings, emissions and energy consumption by the various devices of a wireless communications system (e.g., a telecommunication system) may adversely contribute to the climate. Additionally, the operating expenses to implement and maintain a telecommunication service can be immense. In telecoms, a number of industry-specific factors rooted in countering rising network costs have further shaped efficiency efforts. A continued rise in mobile data traffic, combined with the rising costs of spectrum, capital investment, and ongoing RAN maintenance and upgrades, energy-saving measures in network operations are essential. 5G New Radio (NR) offers a significant energy-efficiency improvement per gigabyte over previous generations of mobility. However, new 5G use cases and the adoption of mm Wave utilizes more cell sites and antennas, which may lead to the prospect of a more efficient network that may result in higher emissions.

Overall, network energy saving is an important aspect for environmental sustainability, such as to reduce the environmental impact (e.g., greenhouse gas emissions), and for operational cost savings. As 5G is becoming pervasive across industries and geographical areas, handling more advanced services and applications requiring very high data rates (e.g., XR), networks are becoming denser, using more antennas, larger bandwidths, and more frequency bands. Energy consumption accounts for a significant energy cost of a mobile network. Most of the energy consumption occurs at the radio access network, and in particular, at the active antenna unit (AAU), with data centers and fiber transport accounting for a smaller share. The power consumption of a radio access can be split into two parts, for example, the dynamic part which is only consumed when data transmission or reception is occurring, and the static part which is energy consumed consistently to maintain the necessary operation of the radio access devices, even when the data transmission and reception is not occurring.

Development and study of a network energy consumption model continues, particularly for BSs, key performance indicators, (KPIs), an evaluation methodology, and to identify and study network energy savings techniques in targeted deployment scenarios. Developments take into consideration how to achieve more efficient operations dynamically and/or semi-statically, and a finer granularity adaptation of transmissions and/or receptions in one or more network energy saving techniques in time, frequency, spatial, and power domains, with potential support and/or feedback from UEs, as well as potential UE assistance information, and information exchange and/or coordination over network interfaces. Considerations include the potential network energy consumption gains, as well as assessing and balancing the impact on network and user performance (e.g., by evaluating KPIs, such as for spectral efficiency, capacity, user perceived throughput (UPT), latency, UE power consumption, complexity, handover performance, call drop rate, initial access performance, service level agreements (SLA) assurance related KPIs, etc.).

In some cases, NEs may expend substantial energy when transmitting SSBs, a PBCH that includes a MIB, a SIB1, as well as other SI and paging messages. In some networks, such as a legacy 5G network, the SIBs (other than SIB1, can be provided on-demand. The communication of SSB and SIB1 may be useful for cell identification, as well as for idle and connected mode mobility. However, continuous paging transmissions can result in unnecessary energy consumption, particularly if a few or none of the UEs being paged are present in a serving cell, where energy conservation is a priority.

Aspects of the present disclosure relate to enabling network energy saving by supporting efficient transmitting of common channels and SI for different types of UE (also referred to as UE device types). In some cases, a 6G network (e.g., a wireless communications system) may be deployed to support both eMBB and IoT UEs, including IoT LPWA UEs. The 6G air interface design can be unified for a single serving cell and single RAT, which can support multiple types of UEs, such as eMBB, IoT, and/or IoT LPWA. The IoT device categories may include both low tier IoT LPWA (e.g., narrowband (NB)-IoT, long-term evolution for machines (LTE-M), etc., as well as high-tier IoT, which includes reduced capability (RedCap) and enhanced reduced capability (eRedcap) devices. The 6G air interface design can be unified for a single serving cell, single radio access technology (RAT), which can support multiple UE device types, such as eMBB and IoT.

Network energy savings may be realized with 6G design by transitioning from an always-on network to an on-demand transmission for common channels and/or signals. Given that most of the network power consumption occurs at the NE (e.g., a BS, a RAN node), optimizing transmission and reception times can significantly reduce power usage. For example, transmission of IoT data can be scheduled during non-peak hours, such as when the serving cell load (e.g., traffic load) from eMBB UEs is minimal (e.g., less than or equal to a cell load threshold). With the network energy savings, IoT data can be transmitted during active time periods of the serving cell, thereby avoiding unnecessary temporal scheduling of IoT data. Instead, the NE may prioritize frequency division multiplexing (FDM) or code division multiplexing (CDM) of the IoT data to minimize extended active time periods.

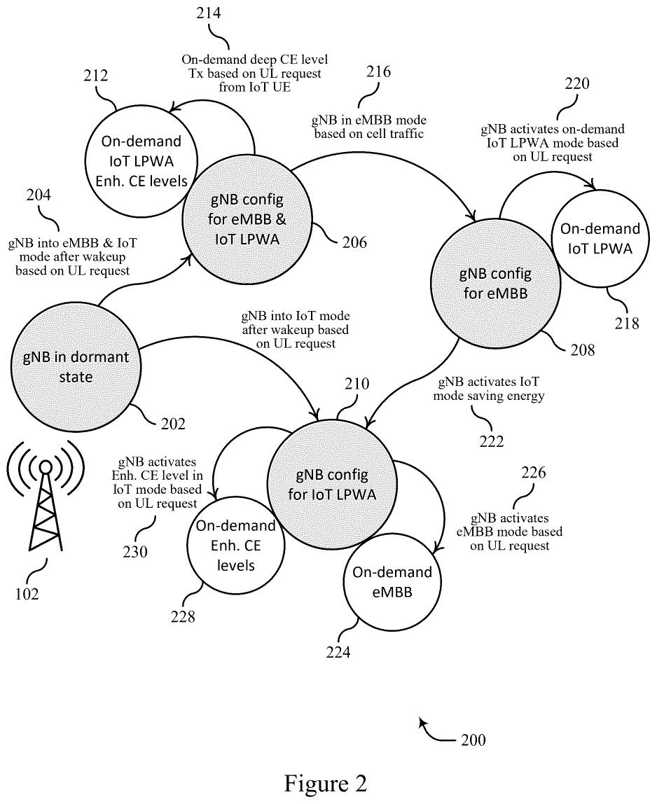

FIG. 2 illustrates an example 200 of BS configurations for different modes of operation, in accordance with aspects of the present disclosure. With reference to a network configuration for different device types, and in aspects of the present disclosure, a 3^{rd} Generation Partnership Project (3GPP) sixth generation (6G) BS (e.g., gNB) can be implemented with multiple modes of operation to provide common channels and signaling, as well as common data services, to different device types (e.g., UE devices). The different device types may include a UE enabled for eMBB (e.g., a UE eMBB device type), as well as an IoT device and/or an IoT LPWA enabled device (e.g., a UE IoT LPWA device type). An IoT LPWA device may be implemented to operate over long distances with minimal power consumption, such as to communicate (e.g., transmit or send) small amounts of data over a wide coverage area.

In some cases, a cell (e.g., serving cell) may refer to a radio access node in communication with a BS (e.g., an NE 102) or including a BS. A cell may have a coverage area, which is a geographic area in which the cell may provide wireless connectivity to devices (e.g., UE devices) within. Different cells may operate on defined frequencies or frequency bands, referred to as subcarriers. In some examples, a UE 104 may establish a wireless connection with a cell, and subsequently that cell may be referred to as a serving cell of the UE 104. In some cases, a BS is described as being able to provide coverage or handle one or more device types, which is to say that the BS manages a connection in a wireless communications system for resource allocation, signaling communications, mobility management, and service quality for the UE.

In implementations, a BS (e.g., a gNB, NE 102) may be idle in a dormant state 202 (i.e., an ultra deep sleep state) to reduce and conserve energy by switching off the radio frequency (RF) transmitter. The BS may periodically monitor for any configured UL occasions for an UL wake up signal (UL-WUS) to start the transmission of common channels and signals from a BS, such as synchronization signals, a PBCH, control resource set #0 (CORESET #0), physical downlink control channel (PDCCH), SIB1 (also commonly referred to as a synchronization signal and required minimum system information (RMSI).

Several common channels and signals may be used in a wireless communications system or network to manage communications between UEs and the network (e.g., BS, gNBs). These common channels and signals provide for network operation and resource allocation and may include any one or more of a primary synchronization signal (PSS) used for initial synchronization to identify the beginning of a cell's frame; a secondary synchronization signal (SSS) used to identify the cell identity within the network; a PBCH for the initial network access; the PDCCH that provides control information to the UEs; a physical downlink shared channel (PDSCH) for SI; a physical random access channel (PRACH) for random access procedures, allowing user devices to request initial access to the network; a channel state information reference signal (CSI-RS) for measuring channel quality and optimizing data transmission; a demodulation reference signal (DM-RS); and a phase tracking reference signal (PT-RS) for tracking and correcting phase noise in high-frequency bands.

In implementations, the BS may receive an UL WUS (at 204) and in response, from the dormant state 202, activate one or more different configurations and/or cell coverage enhancement levels. For example, the BS may activate a configuration 206 for eMBB devices and IoT LPWA devices, activate a configuration 208 for eMBB devices, or activate a configuration 210 for IoT LPWA devices as reduced bandwidth configuration. In some instances, the UL WUS resources and formats having a long guard period can be separately configured for the eMBB and IoT devices. In the case of IoT LPWA devices, the UL WUS can be separately configured for each of the supported coverage enhancement levels (e.g., +10 dB, +20 dB). In implementations of a 6G BS (e.g., gNB, NE 102), the first configuration 206 of common channels and signals can be implemented to provide coverage for both eMBB devices and IoT LPWA devices with the same coverage as that of current eMBB. However, the BS may activate on-demand (e.g., configuration 212) for common channels and signals for other enhanced coverage enhancement levels (i.e., +10 dB, +20 dB), such as based on an UL request (at 214) from an IoT LPWA device.

Since the common channels and signals for IoT LPWA devices utilizes enhanced coverage enhancement levels (i.e., +10 dB, +20 dB) with more repetition to provide deep coverage, the IoT traffic can be scheduled to be transmitted at a particular time. The 6G BS does not activate the common channels and/or signals for IoT LPWA coverage enhancement levels all of the time, since the BS activates a larger number of repetitions for the common channels and signals to reach the coverage enhancement levels, and it can be activated at a particular time or activated based on an on-demand UL request. The 6G BS could signal the activated common channels and signals for a particular coverage enhancement level (or enhancement levels) at a cell in one of the RMSI information elements (e.g., MIB, SIB0-ePBCH/SIB1 and the UL WUS configuration to activate the repetition of common channels and signals to meet the rest of the coverage enhancement). In an implementation, a IoT LPWA device can use the signaled CE level information in RMSI (MIB/SIB1) to perform cell re-selection, such as if there is no UL WUS configuration associated with requesting coverage enhancement for the common channels and/or signals.

The 6G BS can enter into or activate the second configuration 208 based on the type of cell traffic experienced in its cell coverage area (at 216). The second configuration 208 of the 6G BS can provide the common channels and signals for coverage for eMBB devices (e.g., eMBB device types), and can also provide the common channels and signals for on-demand coverage 218 for IoT LPWA devices (e.g., IoT LPWA device types). The BS can implement coverage enhancement levels based on an on-demand UL request from an IoT UE (at 220).

The 6G BS can enter into or activate the third configuration 210 based on a low cell coverage load that sees less demand for data traffic and similar limited load conditions (e.g., energy saving mode at 222). The third configuration 210 of the 6G BS may be activated for reduced bandwidth (BW) operation and to provide coverage for (e.g., handle) IoT device types, or for less resource demanding eMBB data traffic. The 6G BS can increase the BW based on increased demands for eMBB data traffic from eMBB devices (e.g., on-demand 224), or based on an UL request from an eMBB device (at 226). The 6G BS can then activate transmission for repetition of the common channels and/or signals for other enhanced coverage enhancement levels 228 based on an UL request (at 230) from IoT LPWA devices.

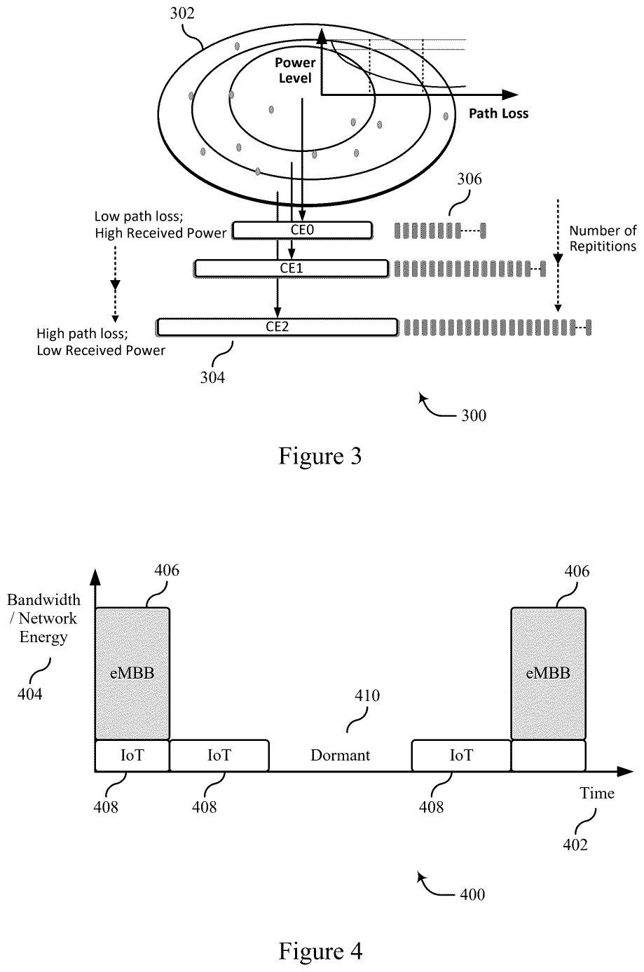

FIG. 3 illustrates an example 300 of BS coverage enhancement levels and repetitions, in accordance with aspects of the present disclosure. This example 300 provides a visual representation of the relationship between coverage distance(s), path loss, and the corresponding signal repetition requirements for different coverage enhancement levels in a wireless network. Coverage zones 302 represent different coverage areas, with a smaller (inner) coverage area corresponding to low path loss and high received power, and larger (outer) coverage areas having higher path loss and lower received power. This example 300 also indicates coverage enhancement (CE) levels 304, such as the levels CE0, CE1, and CE2 that represent increasing levels of coverage enhancement. The CE levels each have a number of repetitions 306, with the number of repetitions for each CE increasing as the CE level increases from CE0 to CE1 to CE2. Increasing in coverage areas from CE0 to CE2, the path loss increases while the received power decreases, which corresponds to the expanding coverage zones 302. Accordingly, this example 300 illustrates how more signal repetitions are needed to compensate for greater path loss in the larger coverage areas. As the coverage enhancement level increases, so does the number of signal repetitions needed to maintain connectivity. With reference to IoT LPWA coverage in comparison to eMBB coverage, the CE0 is the same (or approximately the same) coverage as for eMBB, the CE1 is +10 dB (e.g., repetitions X), and the CE2 is +20 dB (e.g., repetitions Y. (Y>X)). In an implementation, a BS may switch the DL waveform to DFT-S-OFDM for the IoT LPWA device depending on the coverage enhancement levels, for the deep coverage gNB may use DFT-S-OFDM to transmit the PDCCH and/or PDSCH.

With reference to an UL WUS configuration, an UL WUS may be a Zadoff Chu sequence with a separate configuration provided for the eMBB and IoT device types. A BS can receive an UL WUS that identifies a UE device type, such as an eMBB device or an IoT LPWA device. In implementations, a subset of a configuration for PRACH formats that provide a greater cell coverage area for eMBB or IoT LPWA devices can be used as baseline for the eMBB and IoT device types configuration(s). Further, an UL WUS can be separately configured for each of the enhanced coverage enhancement levels (e.g., +10 dB, +20 dB), and the format of the UL WUS signal, sub-carrier spacing (SCS), and repetition may be different due to the enhanced coverage level requirement, such as in an implementation, an UL WUS utilizing the PRACH formats can select a configuration that provides an IoT cell coverage area. For example, a long sequence with a long guard period (e.g., 7.5 kHz or 3.75 kHz SCS) can be used for an UL WUS.

The UL WUS cell discontinuous reception (DRX)-reception active time periods and the bandwidth of reception can be separately configured within the cell dormant state. The cell active reception time window in each period may be shorter for an eMBB device, while the cell active reception time window in each period may be longer for an IoT LPWA device due to the BS receiving a large number of repetitions of an UL WUS signal from deep coverage of an IoT LPWA device. Hence, the cell active reception time windows that may also partially overlap depend on the coverage enhancement levels and device types that may be configured, and where only one cell DRX active period configuration can be activated before the cell reverts to the dormant state. Any one of the multiple configurations can be activated in a MIB, in a SI block 0 (SIB0), PBCH or SIB1.

A UE performing an initial cell search may try to acquire a default period (e.g., 20 ms of a time domain signal) to search for synchronization signals within the default period using the sliding window approach. If the UE does not find a synchronization signal within the time window, the UE may transmit the UL WUS, with resources that may be preconfigured via public land mobile network (PLMN), universal subscriber identity module (USIM), etc., requesting the transmission of the on-demand synchronization signals. The UE may maintain a timer after the transmission of a UL WUS. Since the UE does not know the periodicity of the synchronization signal transmission at the BS, the BS, after receiving the ULWUS, may check whether to send the on-demand synchronization signals or not, depending on a time offset between the reception of the ULWUS and the periodic synchronization signal. If the time offset is within a certain configured value (i.e., can be related to a UE timer value), then the BS does not transmit the on-demand synchronization signals, and may transmit the periodic synchronization signal. This means that the periodic synchronization signal transmission may be within a timer value at the UE. After the timer has expired, the UE may search for a synchronization signal in the next raster frequency and so on. If the UE does not find the synchronization signal in any of the next raster frequencies, the UE may reselect to another frequency band.

FIG. 4 illustrates an example 400 of BS activity based on UE device types, in accordance with aspects of the present disclosure. In this example 400, a time axis 402 indicates a progression of network activity, and a bandwidth and/or network energy axis 404 indicates a level of resource utilization. Accordingly, this example 400 illustrates network activity over time, showing how bandwidth and energy usage vary for different device types in a network. The example 400 includes eMBB representations 406 that indicate periods of high bandwidth and energy usage for eMBB type devices. The example 400 also includes indications of IoT 408 operating at a lower bandwidth and/or energy level compared to eMBB. The dormant period 410 indicates a period of very low or no network activity. This example 400 illustrates an ability of the network to adapt energy and bandwidth usage based on the type of devices being served, and how the network can be implemented to alternate between the high-bandwidth eMBB operations, lower-bandwidth IoT communications, and energy-saving dormant periods. This further illustrates the described aspects of efficient network configuration for different device types, allowing for optimized energy usage in 6G networks.

With reference to cell bandwidth adaptation, the CBW of a cell can be adapted depending on the signaling and data traffic type, cell load, and/or network power consumption. The CBW can be signaled to an idle mode UE in the MIB or in the SIB1, which may inform the UE to tune its reception BW accordingly to save UE power. Also, the UE may transmit an UL signal within the CBW, where a CBW index from a table of CBW values can be used as an indication. A cell may also signal separate CBW for cell transmission and cell reception, where the UE may use the CBW-transmit (Tx) to tune the UE receive (Rx) BW, while CBW-Rx can be used for a UE transmission bandwidth requirement. The CBW adaptation may impact the initial downlink (DL) and initial UL bandwidth part (BWP), CORESET #0 and SSB multiplexing, SIB0 and SIB1 bandwidth, etc. An initial mode UE may also use the CBW in the cell selection procedure, while the UE may perform cell reselection if its service needs exceed the CBW. The UE may also perform cell reselection after receiving a paging message, if the paging message indicates the type of service, and UE may perform cell reselection if its service needs exceed the CBW.

The connected mode cell bandwidth adaptation can be semi-statically indicated using the SIB1 message, or dynamically indicated using the group common downlink control information (DCI). The group common DCI can be transmitted in a CORESET of each BWP configured within a carrier. The information may include a CBW index from a table of CBW values and deactivation of a BWP index for transmission or reception, or both. The information may also include a new BWP size of a BWP index. The group common DCI may repeatedly signal the same content in every configured BWP or BWP specific content.

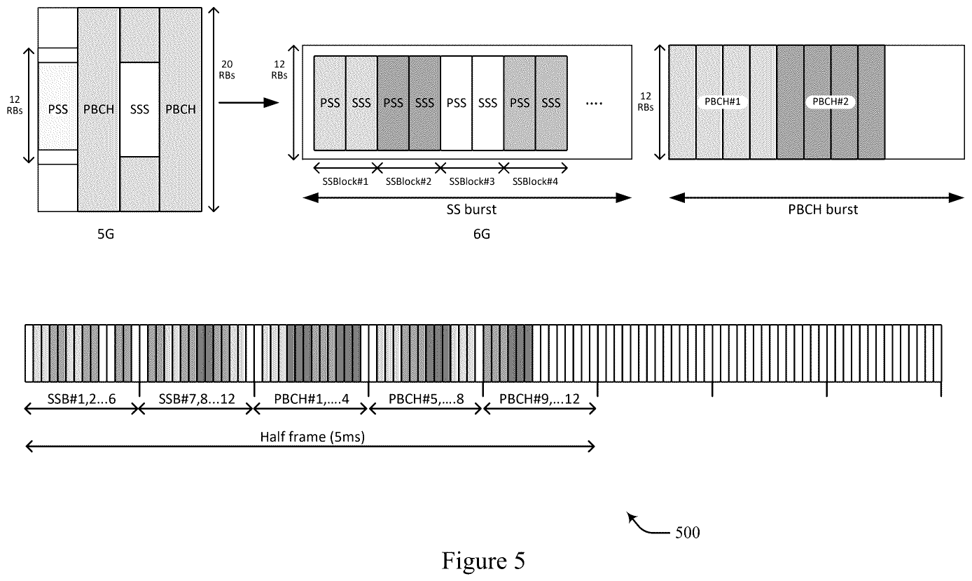

FIG. 5 illustrates an example 500 of synchronization signal and PBCH configuration, in accordance with aspects of the present disclosure. This example 500 represents common channels and signals adaptation for the device types and respective coverage. The synchronization signal (SS) and the PBCH can be separately transmitted within a half frame (5 ms) of a radio frame (10 ms) where the PBCH #1 can be correspondingly transmitted for the synchronization signals #1 using the same beam. The time domain offset between the SS and whether the SS and PBCH are transmitted in the first half frame or in the second half frame within a radio frame can be indicated in the MIB. The reason for separating the SS and PBCH may be related to the coverage enhancements needed for the IoT device type, which requires more repetition. Instead of repeating the entire 5G unified SSB block, the PBCH signals can be separately repeated for coverage needed for the IoT device type. Moreover, network energy savings can be achieved by transmitting the PBCH with less periodicity compared to the synchronization signal periodicity. For example, the synchronization signals can be transmitted using 80 ms periodicity while the PBCH periodicity can be 160 ms.

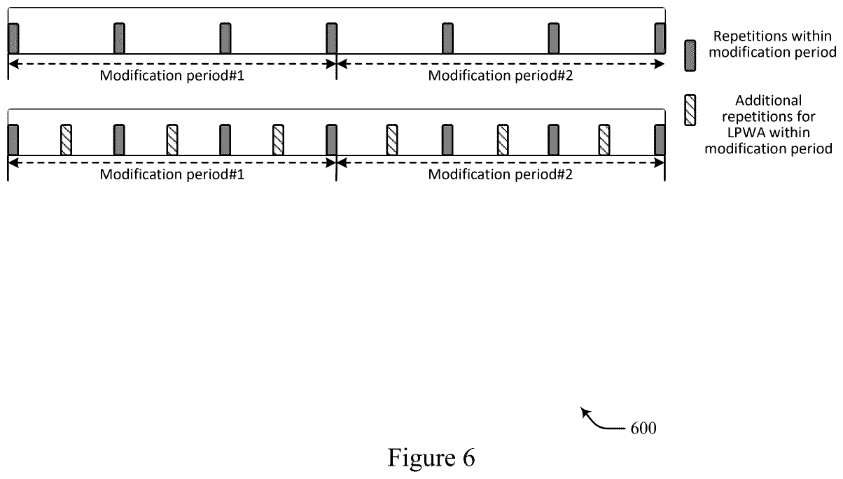

FIG. 6 illustrates an example 600 of modification periods for repetition of the PBCH signal for IoT device types, in accordance with aspects of the present disclosure. This example 600 indicates that the repetition of the PBCH signal for IoT device types for the deep coverage area can be performed within the modification period of PBCH. A separate on-demand PBCH configuration to receive the extra repetitions may be provided to the IoT devices within the modification period as part of the IoT LPWA transmission for enhanced coverage enhancement levels. In implementations, the on-demand PBCH configuration may be activated using the UL WUS configuration associated to a device type or coverage enhancement levels requesting common channel and signal transmission. The on-demand PBCH may be configured with a ‘K’ number of PBCHs transmissions and may assume that the K number of PBCHs are within the same modification periods or within a same modification period of the periodic PBCHs. A MIB value tag may indicate the change in the modification period of PBCH. In another implementation, an UL WUS may be associated to the K number of transmissions of on-demand common channels burst and signals, such as including PBCHs, CORESET #0, and SIB1 as a single burst.

In another implementation, in a configuration where the BS transmits common channels and signals for the eMBB and IoT LPWA for the same coverage area, then the BS may use the unified SSB block containing the synchronization signal and PBCHs (as in 5G NR) while the BS may separately provide on-demand or periodic repeated transmissions of only PBCHs for the IOT LPWA to meet the coverage enhancement levels. This type of standalone extra PBCHs repetition configuration to meet the coverage enhancement level can be signaled in the MIB of the unified SSB, a table index containing a time offset to the SSBs, and the number of repetitions may be signaled in the MIB. The MIB contains a ‘K’ number of transmissions of on-demand PBCHs as an index to a table, or can be provided together with the time offset value using the table index. Similarly, a same SIB1 may contain a configuration for both eMBB and IoT while an on-demand SIB1 may be provided to the IoT LPWA with repetition to meet the coverage enhancement level. In another implementation, the SIB1 for IoT LPWA can be a separate configuration containing a required minimum SI, such as paging, RACH, bandwidth part configuration, cell selection, and barring parameters. The SIB1 for IoT LPWA can be repeatedly transmitted with a different modification period to meet the enhanced coverage levels.

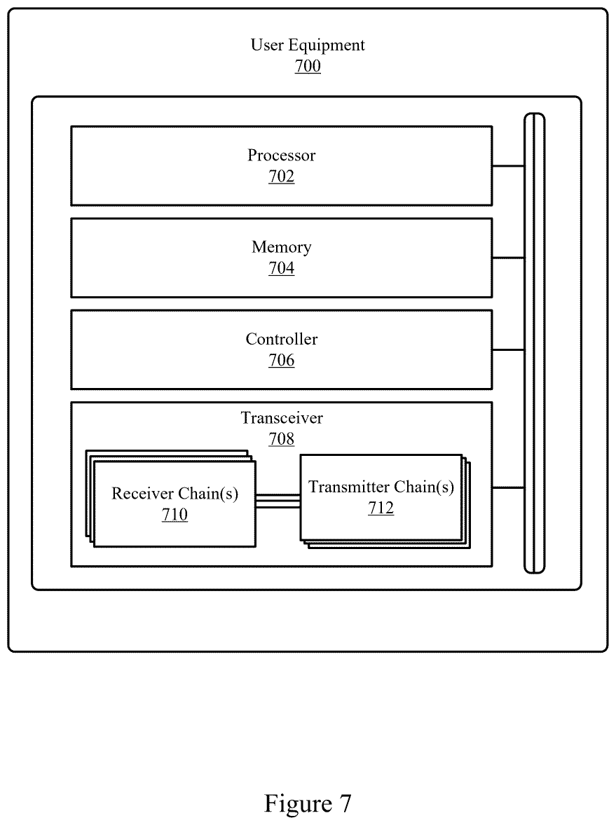

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for transmitting, to a NE, an UL WUS for on-demand transmission of one or more common channels or signals to provide cell coverage for a type of the UE; and receiving, from the NE, an acknowledgement of a network configuration of a set of network configurations to provide the cell coverage based on the UL WUS and the type of the UE.

Additionally, the UE 700 may be configured to or operable to support any one or combination of the UL WUS is configured to identify the type of the UE as at least one of enabled for eMBB, an IoT device, or an IoT LPWA device. The multiple network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA.

Additionally, or alternatively, the UE 700 may support at least one memory (e.g., the memory 704) and at least one processor (e.g., the processor 702) coupled with the at least one memory and configured to or operable to cause the UE to transmit, to a NE, an UL WUS for on-demand transmission of one or more common channels or signals to provide cell coverage for a type of the UE; and receive, from the NE, an acknowledgement of a network configuration of a set of network configurations to provide the cell coverage based on the UL WUS and the type of the UE.

Additionally, the UE 700 may be configured to or operable to support any one or combination of the UL WUS is configured to identify the type of the UE as at least one of enabled for eMBB, an IoT device, or an IoT LPWA device. The multiple network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

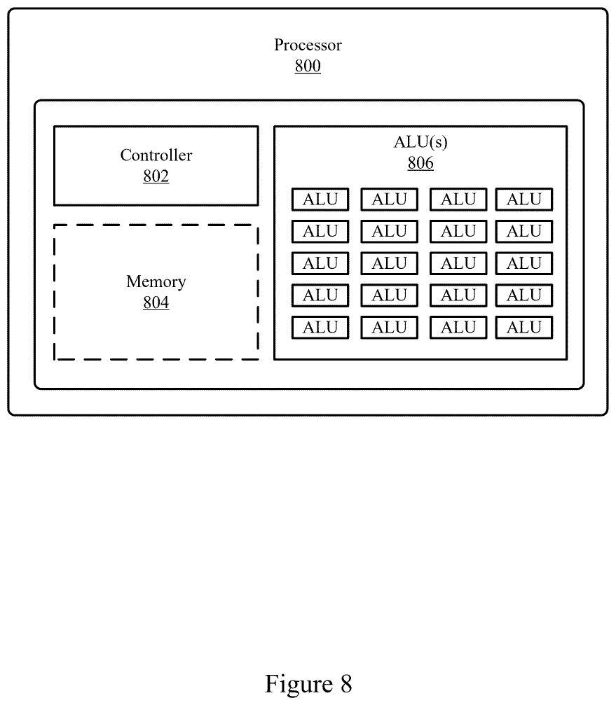

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to support at least one controller (e.g., the controller 802) coupled with at least one memory (e.g., the memory 804) and configured to or operable to cause the processor to transmit, to a NE, an UL WUS for on-demand transmission of one or more common channels or signals to provide cell coverage for a type of a UE; and receive, from the NE, an acknowledgement of a network configuration of a set of network configurations to provide the cell coverage based on the UL WUS and the type of the UE.

Additionally, the processor 800 may be configured to or operable to support any one or combination of the UL WUS is configured to identify the type of the UE as at least one of enabled for eMBB, an IoT device, or an IoT LPWA device. The multiple network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA.

The processor 800 may support wireless communication in accordance with examples as disclosed herein. The processor 800 may be configured to support at least one controller (e.g., the controller 802) coupled with at least one memory (e.g., the memory 804) and configured to or operable to cause the processor to receive, from a UE, an UL WUS for on-demand transmission of one or more common channels or signals to provide cell coverage for a type of the UE; and activate a network configuration of a set of network configurations based on the UL WUS and the type of the UE, where each network configuration of the set of network configurations corresponds to a respective mode of operation of an NE associated with a respective type of UE of a set of types of UEs, and where each respective type of UE corresponds to a respective cell coverage by the one or more common channels or signals.

Additionally, the processor 800 may be configured to or operable to support any one or combination of the UL WUS is configured to identify the type of the UE, and the set of types of UEs include one or more of a first UE enabled for eMBB; a second UE configured as an IoT device; or a third UE configured as an IoT LPWA device. The at least one controller is operable to cause the processor to implement a cell coverage enhancement level based on the UL WUS and the type of the UE. The at least one controller is operable to cause the processor to determine at least one of an on-demand mode of operation of the NEor the cell coverage enhancement level, and where the cell coverage enhancement level includes an adapted CBW of the cell coverage. The network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA. The at least one controller is operable to cause the processor to conserve energy in an idle state; wake up responsive to the UL WUS; and activate the network configuration as at least one of the first network configuration, the second network configuration, or the at least third network configuration. The at least one controller is operable to cause the processor to enable the first network configuration to provide eMBB cell coverage; receive a subsequent UL WUS for on-demand IoT LPWA cell coverage; and enable at least one of the second network configuration to provide the IoT LPWA cell coverage, or the at least third network configuration to provide both the eMBB cell coverage and the IoT LPWA cell coverage. The at least one controller is operable to cause the processor to enable the second network configuration to provide IoT LPWA cell coverage; receive a subsequent UL WUS for on-demand eMBB cell coverage; and enable at least one of the first network configuration to provide the eMBB cell coverage, or the at least third network configuration to provide both the eMBB cell coverage and the IoT LPWA cell coverage. The at least one controller is operable to cause the processor to enable the second network configuration to provide IoT LPWA cell coverage; receive a subsequent UL WUS for an on-demand cell coverage enhancement level; and enable a different network configuration to provide at least the cell coverage enhancement level. The at least one controller is operable to cause the processor to enable the third network configuration to provide both eMBB cell coverage and IoT LPWA cell coverage; receive a subsequent UL WUS for an on-demand cell coverage enhancement level; and enable a different network configuration to provide at least the cell coverage enhancement level.

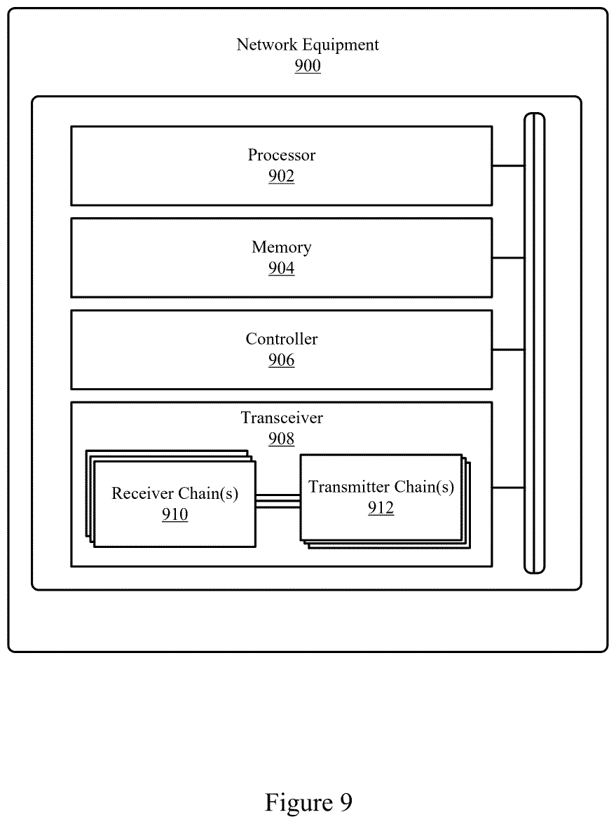

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for receiving, from a UE, an UL WUS for on-demand transmission of one or more common channels or signals to provide cell coverage for a type of the UE; and activating a network configuration of a set of network configurations based on the UL WUS and the type of the UE, where each network configuration of the set of network configurations corresponds to a respective mode of operation of the NE associated with a respective type of UE of a set of types of UEs, and where each respective type of UE corresponds to a respective cell coverage by the one or more common channels or signals.

Additionally, the NE 900 may be configured to or operable to support any one or combination of the UL WUS is configured to identify the type of the UE, and the set of types of UEs include one or more of a first UE enabled for eMBB; a second UE configured as an IoT device; or a third UE configured as an IoT LPWA device. The method further including implementing a cell coverage enhancement level based on the UL WUS and the type of the UE. The method further including determining at least one of an on-demand mode of operation of the NEor the cell coverage enhancement level, and where the cell coverage enhancement level includes an adapted CBW of the cell coverage. The network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA. The method further including conserving energy in an idle state; waking up responsive to the UL WUS; and activating the network configuration as at least one of the first network configuration, the second network configuration, or the at least third network configuration. The method further including enabling the first network configuration to provide eMBB cell coverage; receiving a subsequent UL WUS for on-demand IoT LPWA cell coverage; and enabling at least one of the second network configuration to provide the IoT LPWA cell coverage, or the at least third network configuration to provide both the eMBB cell coverage and the IoT LPWA cell coverage. The method further including enabling the second network configuration to provide IoT LPWA cell coverage; receiving a subsequent UL WUS for on-demand eMBB cell coverage; and enabling at least one of the first network configuration to provide the eMBB cell coverage, or the at least third network configuration to provide both the eMBB cell coverage and the IoT LPWA cell coverage. The method further including enabling the second network configuration to provide IoT LPWA cell coverage; receiving a subsequent UL WUS for an on-demand cell coverage enhancement level; and enabling a different network configuration to provide at least the cell coverage enhancement level. The method further including enabling the third network configuration to provide both eMBB cell coverage and IoT LPWA cell coverage; receiving a subsequent UL WUS for an on-demand cell coverage enhancement level; and enabling a different network configuration to provide at least the cell coverage enhancement level.

Additionally, or alternatively, the NE 900 may support at least one memory (e.g., the memory 904) and at least one processor (e.g., the processor 902) coupled with the at least one memory and configured to or operable to cause the NE to receive, from a UE, an UL WUS for on-demand transmission of one or more common channels or signals to provide cell coverage for a type of the UE; and activate a network configuration of a set of network configurations based on the UL WUS and the type of the UE, where each network configuration of the set of network configurations corresponds to a respective mode of operation of the NE associated with a respective type of UE of a set of types of UEs, and where each respective type of UE corresponds to a respective cell coverage by the one or more common channels or signals.

Additionally, the NE 900 may be configured to or operable to support any one or combination of the UL WUS is configured to identify the type of the UE, and the set of types of UEs include one or more of a first UE enabled for eMBB; a second UE configured as an IoT device; or a third UE configured as an IoT LPWA device. The at least one processor is operable to cause the NE to implement a cell coverage enhancement level based on the UL WUS and the type of the UE. The at least one processor is operable to cause the NE to determine at least one of an on-demand mode of operation of the NEor the cell coverage enhancement level, and where the cell coverage enhancement level includes an adapted CBW of the cell coverage. The network configurations include one or more of a first network configuration to provide the cell coverage for the UE as eMBB; a second network configuration to provide the cell coverage for the UE as an IoT device enabled for LPWA; or at least a third network configuration to provide the cell coverage for both eMBB and IoT LPWA. The at least one processor is operable to cause the NE to conserve energy in an idle state; wake up responsive to the UL WUS; and activate the network configuration as at least one of the first network configuration, the second network configuration, or the at least third network configuration. The at least one processor is operable to cause the NE to enable the first network configuration to provide eMBB cell coverage; receive a subsequent UL WUS for on-demand IoT LPWA cell coverage; and enable at least one of the second network configuration to provide the IoT LPWA cell coverage, or the at least third network configuration to provide both the eMBB cell coverage and the IoT LPWA cell coverage. The at least one processor is operable to cause the NE to enable the second network configuration to provide IoT LPWA cell coverage; receive a subsequent UL WUS for on-demand eMBB cell coverage; and enable at least one of the first network configuration to provide the eMBB cell coverage, or the at least third network configuration to provide both the eMBB cell coverage and the IoT LPWA cell coverage. The at least one processor is operable to cause the NE to enable the second network configuration to provide IoT LPWA cell coverage; receive a subsequent UL WUS for an on-demand cell coverage enhancement level; and enable a different network configuration to provide at least the cell coverage enhancement level. The at least one processor is operable to cause the NE to enable the third network configuration to provide both eMBB cell coverage and IoT LPWA cell coverage; receive a subsequent UL WUS for an on-demand cell coverage enhancement level; and enable a different network configuration to provide at least the cell coverage enhancement level.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

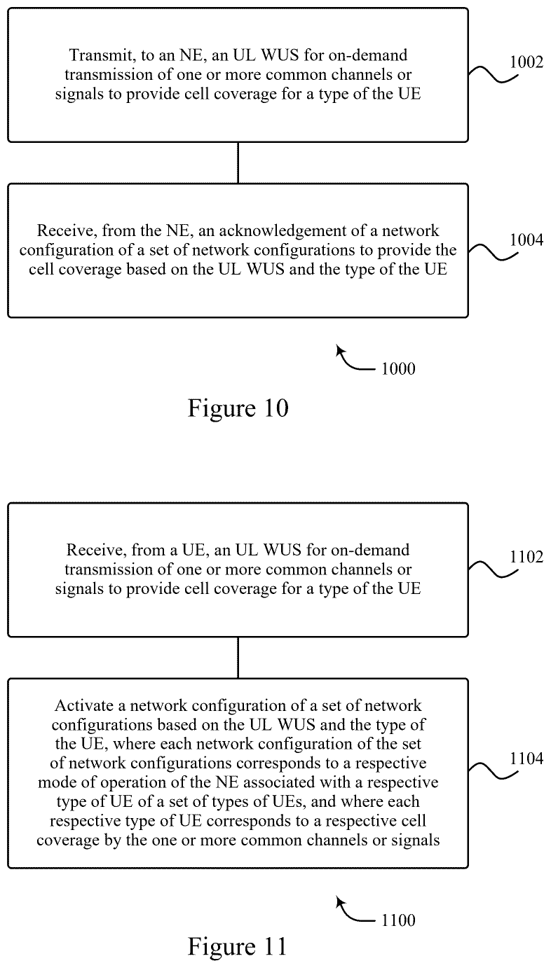

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include transmitting, to an NE, an UL WUS for on-demand transmission of one or more common channels or signals to provide cell coverage for a type of the UE. The operations of 1002 may be performed in accordance with examples as described herein. In some implementations, aspects of the operations of 1002 may be performed by a UE as described with reference to FIG. 7.

At 1004, the method may include receiving, from the NE, an acknowledgement of a network configuration of a set of network configurations to provide the cell coverage based on the UL WUS and the type of the UE. The operations of 1004 may be performed in accordance with examples as described herein. In some implementations, aspects of the operations of 1004 may be performed by a UE as described with reference to FIG. 7.

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include receiving, from a UE, an UL WUS for on-demand transmission of one or more common channels or signals to provide cell coverage for a type of the UE. The operations of 1102 may be performed in accordance with examples as described herein. In some implementations, aspects of the operations of 1102 may be performed by an NE as described with reference to FIG. 9.

At 1104, the method may include activating a network configuration of a set of network configurations based on the UL WUS and the type of the UE, where each network configuration of the set of network configurations corresponds to a respective mode of operation of the NE associated with a respective type of UE of a set of types of UEs, and where each respective type of UE corresponds to a respective cell coverage by the one or more common channels or signals. The operations of 1104 may be performed in accordance with examples as described herein. In some implementations, aspects of the operations of 1104 may be performed by an NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and operable to cause the NE to:
receive, from a user equipment (UE), an uplink (UL) wake-up signal (WUS) for on-demand transmission of one or more common channels or signals to provide cell coverage for a type of the UE; and
activate a network configuration of a set of network configurations based at least in part on the UL WUS and the type of the UE, wherein each network configuration of the set of network configurations corresponds to a respective mode of operation of the NE associated with a respective type of UE of a set of types of UEs, and wherein each respective type of UE corresponds to a respective cell coverage by the one or more common channels or signals.

2. The NE of claim 1, wherein the UL WUS is configured to identify the type of the UE, and the set of types of UEs include one or more of:
a first UE enabled for enhanced mobile broadband (eMBB);
a second UE configured as an Internet-of-things (IoT) device; or
a third UE configured as an IoT low power wide area network (LPWA) device.

3. The NE of claim 1, wherein the at least one processor is operable to cause the NE to implement a cell coverage enhancement level based at least in part on the UL WUS and the type of the UE.

4. The NE of claim 3, wherein the at least one processor is operable to cause the NE to determine at least one of an on-demand mode of operation of the NE or the cell coverage enhancement level, and wherein the cell coverage enhancement level includes an adapted common bandwidth (CBW) of the cell coverage.

5. The NE of claim 1, wherein the set of network configurations include one or more of:
a first network configuration to provide the cell coverage for the UE as enhanced mobile broadband (eMBB);
a second network configuration to provide the cell coverage for the UE as an Internet-of-things (IoT) device enabled for low power wide area network (LPWA); or
at least a third network configuration to provide the cell coverage for both eMBB and IoT LPWA.

6. The NE of claim 5, wherein the at least one processor is operable to cause the NE to:
enable the first network configuration to provide eMBB cell coverage;
receive a subsequent UL WUS for on-demand IoT LPWA cell coverage; and
enable at least one of the second network configuration to provide the IoT LPWA cell coverage, or the at least third network configuration to provide both the eMBB cell coverage and the IoT LPWA cell coverage.

7. The NE of claim 5, wherein the at least one processor is operable to cause the NE to:
enable the second network configuration to provide IoT LPWA cell coverage;
receive a subsequent UL WUS for on-demand eMBB cell coverage; and
enable at least one of the first network configuration to provide the eMBB cell coverage, or the at least third network configuration to provide both the eMBB cell coverage and the IoT LPWA cell coverage.

8. The NE of claim 5, wherein the at least one processor is operable to cause the NE to:
enable the second network configuration to provide IoT LPWA cell coverage;
receive a subsequent UL WUS for an on-demand cell coverage enhancement level; and
enable a different network configuration to provide at least the cell coverage enhancement level.

9. The NE of claim 5, wherein the at least one processor is operable to cause the NE to:
enable the third network configuration to provide both eMBB cell coverage and IoT LPWA cell coverage;
receive a subsequent UL WUS for an on-demand cell coverage enhancement level; and
enable a different network configuration to provide at least the cell coverage enhancement level.

10. A method performed by a network equipment (NE), the method comprising:
receiving, from a user equipment (UE), an uplink (UL) wake-up signal (WUS) for on-demand transmission of one or more common channels or signals to provide cell coverage for a type of the UE; and
activating a network configuration of a set of network configurations based at least in part on the UL WUS and the type of the UE, wherein each network configuration of the set of network configurations corresponds to a respective mode of operation of the NE associated with a respective type of UE of a set of types of UEs, and wherein each respective type of UE corresponds to a respective cell coverage by the one or more common channels or signals.

11. The method of claim 10, wherein the UL WUS is configured to identify the type of the UE, and the set of types of UEs include one or more of:
a first UE enabled for enhanced mobile broadband (eMBB);
a second UE configured as an Internet-of-things (IoT) device; or
a third UE configured as an IoT low power wide area network (LPWA) device.

12. The method of claim 10, wherein the set of network configurations include one or more of:
a first network configuration to provide the cell coverage for the UE as enhanced mobile broadband (eMBB);
a second network configuration to provide the cell coverage for the UE as an Internet-of-things (IoT) device enabled for low power wide area network (LPWA); or
at least a third network configuration to provide the cell coverage for both eMBB and IoT LPWA.

13. The method of claim 12, further comprising:
enabling the first network configuration to provide eMBB cell coverage;
receiving a subsequent UL WUS for on-demand IoT LPWA cell coverage; and
enabling at least one of the second network configuration to provide the IoT LPWA cell coverage, or the at least third network configuration to provide both the eMBB cell coverage and the IoT LPWA cell coverage.

14. The method of claim 12, further comprising:
enabling the second network configuration to provide IoT LPWA cell coverage;
receiving a subsequent UL WUS for on-demand eMBB cell coverage; and
enabling at least one of the first network configuration to provide the eMBB cell coverage, or the at least third network configuration to provide both the eMBB cell coverage and the IoT LPWA cell coverage.

15. The method of claim 12, further comprising:
enabling the second network configuration to provide IoT LPWA cell coverage;
receiving a subsequent UL WUS for an on-demand cell coverage enhancement level; and
enabling a different network configuration to provide at least the cell coverage enhancement level.

16. The method of claim 12, further comprising:
enabling the third network configuration to provide both eMBB cell coverage and IoT LPWA cell coverage;
receiving a subsequent UL WUS for an on-demand cell coverage enhancement level; and
enabling a different network configuration to provide at least the cell coverage enhancement level.

17. A user equipment (UE) for wireless communication, comprising:
at least one memory; and
at least one processor coupled with the at least one memory and operable to cause the UE to:
transmit, to a network equipment (NE), an uplink (UL) wake-up signal (WUS) for on-demand transmission of one or more common channels or signals to provide cell coverage for a type of the UE; and
receive, from the NE, an acknowledgement of a network configuration of a set of network configurations to provide the cell coverage based at least in part on the UL WUS and the type of the UE.

18. The UE of claim 17, wherein the UL WUS is configured to identify the type of the UE as at least one of enabled for enhanced mobile broadband (eMBB), an Internet-of-things (IoT) device, or an IoT low power wide area network (LPWA) device.

19. A method performed by a user equipment (UE), the method comprising:
transmitting, to a network equipment (NE), an uplink (UL) wake-up signal (WUS) for on-demand transmission of one or more common channels or signals to provide cell coverage for a type of the UE; and
receiving, from the NE, an acknowledgement of a network configuration of a set of network configurations to provide the cell coverage based at least in part on the UL WUS and the type of the UE.

20. The method of claim 19, wherein the UL WUS is configured to identify the type of the UE as at least one of enabled for enhanced mobile broadband (eMBB), an Internet-of-things (IoT) device, or an IoT low power wide area network (LPWA) device.
